(19) United States
(12) Patent Application Publication
(10) Pub. No.: US 2015/0314576 A1
(43) Pub. Date: Nov. 5, 2015

(54) FLEXIBLE SUBSTRATE, MANUFACTURING METHOD THEREOF, AND DISPLAY APPARATUS

(71) Applicant: BOE TECHNOLOGY GROUP CO., LTD., Beijing (CN)

(72) Inventors: Tao SUN, Beijing (CN); Mingzhe XIE, Beijing (CN)

(21) Appl. No.: 14/403,402

(22) PCT Filed: Apr. 18, 2014
(86) PCT No.: PCT/CN2014/075661

§ 371 Date: Nov. 24, 2014

(30) Foreign Application Priority Data
Sep. 29, 2013 (CN) 201310456088.3

(51) Int. Cl. B32B 27/12; B32B 27/36; B32B 5/02; B05D 3/00; B05D 7/00

(52) U.S. Cl. CPC B32B 27/12; B05D 3/007; B05D 7/56; B32B 5/02; B32B 27/36; B32B 2262/101; B32B 2262/106; B32B 2457/20

(57) ABSTRACT

The present invention relates to a flexible display technical filed, and particularly to a flexible substrate and a manufacturing method thereof, and a display apparatus comprising the flexible substrate. The flexible substrate comprises a base, a plurality of flexible layers are provided on the base, and a fiber layer is provided between two adjacent flexible layers. The flexible substrate of the present invention is formed by flexible layers and fiber layers, which can effectively prevent the flexible layers from deformation due to a high temperature, can reduce stress and increase adhesion of a thin film on the substrate to the greatest extent, and bending and compression strength of the substrate are improved.

### TECHNICAL FIELD

The present invention relates to a field of flexible display technology, and particularly, to a flexible substrate, a manufacturing method thereof, and a display apparatus comprising the flexible substrate.

### BACKGROUND ART

With a rapid development of electronic information technology and consumer's demand being higher and higher, consumers pay more and more attention to quality and display mode of a display. Consumers are not satisfied with simple visual perception, but also require a display being thinner, portable, personalized and so on. Development from a thick and heavy CRT display to a thin and light LCD is a qualitative leap, now there is also a great breakthrough for the LCD in display quality such as high resolution, narrow frame and low power consumption. In recent years, functions such as 3D, touch, etc. with a rapid development are welcomed by consumers. However, due to inherent characteristics of liquid crystal material, the LCD has defects of slow response speed, low contrast, and small visual angle, which is still difficult to break through currently. Now emergence of a next generation OLED (Organic Light Emitting Device) display technology is widely concerned, because of its advantages of excellent quality, no limit to visual angle and contrast, thinness (about 0.2 mm) and light weight, and self-luminescence, the OLED display technology becomes a competitive display technology that display panel makers are scrambling to develop.

In addition, traditional displays are flat panel displays, which cannot be bent arbitrarily. A future trend is to present large amounts of information on a flexible body, that is, to perform display on a flexible display (i.e., to realize flexible display). An official definition of the flexible display is a display device in which a display screen and a module can be mechanically bent during any process of packaging a substrate, production, storage, usage, operation, connection between processes, carrying, transportation and so on (see IEC TC110 WG8). A Key to realize flexible display is to provide a flexible display, and a key to provide the flexible display is to use appropriate substrate technology, array technology and encapsulating technology. Currently, displays capable of realizing flexible display include displays of LCD, OLED, EPD (electronic paper display), PDLC (polymer dispersed liquid crystal) and ChLC (cholesteric liquid crystal) modes, substrates used in the displays mainly include substrates of three forms of ultra-thin glass, metal foil, and plastic, and array technologies used in the displays, in addition to traditional amorphous silicon technology, also include technologies of low temperature poly-silicon (LTPS), oxide, and organic thin film transistor (OTFT) which are gradually developed in recent years. For a display of OLED mode, as OLED devices are very sensitive to water vapor and oxygen, and performance degradation for the OLED devices are easily occurred, the OLED devices must be encapsulated by mainly using substrate and thin film (TFE).

An ultra-thin glass has a good barrier property for water vapor and oxygen, and transparency thereof is good, but it is sensitive to crack, and shock resistance and bending performance thereof are poor, so that it is not easy to realize a process of roll to roll, and it is very difficult to develop an ultra-thin flexible glass. A metal foil substrate has a barrier function for water vapor and oxygen, and it has a high temperature resistance, a low cost, and a malleability itself, so that it is easy to realize a process of roll to roll, however, surface of the metal foil is rough (roughness is about 0.6 μm), even it is subjected to a polishing treatment, a planarization layer is still needed to be applied thereon, which increases thickness of the substrate, resulting in an increase of thickness of a display. A plastic substrate has a better flexibility, a lighter weight, and a higher shock resistance, however, the plastic substrate is not resistant to high temperature, so that TFT processes must be completed at a very low temperature, which will increase defects in a thin film, while at a high temperature, deformation amount of the plastic is too large, and at a temperature higher than glass transition temperature, deformation amount of the plastic is increased seriously, moreover, lattice match between the plastic substrate and the thin film is not as good as that between the glass substrate and the thin film, so that the thin film is easy to fall off from the plastic substrate.

### SUMMARY

### Technical Problem to be Solved

In view of above, a technical problem to be solved by the present invention is to provide a flexible substrate and a manufacturing method thereof, and a display apparatus comprising the flexible substrate, wherein the flexible substrate is not easy to deform and has both of good strength and good flexibility.

### Technical Solutions

In order to solve the technical problem described above, an aspect of the present invention provides a flexible substrate comprising a base, wherein a plurality of flexible layer are provided on the base, and a fiber layer is provided between two adjacent flexible layers.

Preferably, the flexible layers are made of resin material.

Preferably, the resin material is resin plastic.

Preferably, the resin plastic is made of polyimide, polyethylene naphthalate or polyethylene terephthalate.

Preferably, the fiber layer is formed by interlaced fibers.

Preferably, the fibers are interlaced in (0°, 90°) or (45°, −45°) orthogonal mode.

Preferably, the fibers are glass fibers or carbon fibers.

Preferably, the fibers are in circle bundle shapes.

Another aspect of the present invention provides a manufacturing method of a flexible substrate. The method comprises steps of step S1, covering a flexible layer made of resin material on a base; step S2, performing a pre-curing process on the flexible layer; step S3, covering a fiber layer on the flexible layer, the fiber layer is formed by interlaced fibers; step S4, continuously covering a flexible layer made of resin material on the fiber layer; step S5, repeating steps S2 to S4 many times.

Preferably, the method further comprises: step S6, after finishing the step S5, performing vacuum pumping process on the flexible substrate, and performing curing and heat preservation process.

Preferably, curing time of the pre-curing in the step S2 is 80 minutes to 150 minutes, and curing temperature thereof is 80° C. to 200° C.

Preferably, curing time of the curing in the step S6 is 60 minutes to 120 minutes.

Further another aspect of the present invention provides a display apparatus comprising above flexible substrate.

### Technical Effects

In the flexible substrate and the manufacturing method thereof, and the display apparatus of the present invention, the flexible substrate is formed by flexible layers and fiber layers, which can effectively prevent the flexible layers from deformation due to a high temperature, can reduce stress and increase adhesion of a thin film on the substrate to the greatest extent, and bending and compression strength of the substrate are improved.

### BRIEF DESCRIPTION OF THE DRAWINGS

FIG. 1 shows a structural diagram of a flexible substrate according to an embodiment of the present invention.

FIG. 2 shows a diagram of fibers in an orthogonal mode in a flexible substrate according to an embodiment of the present invention.

FIG. 3 shows a diagram of fibers in another orthogonal mode in a flexible substrate according to an embodiment of the present invention.

FIG. 4 shows a flowchart of a manufacturing method of a flexible substrate according to an embodiment of the present invention.

### DETAILED DESCRIPTION OF THE PREFERRED EMBODIMENTS

Specific implementations of the present invention will be described below in detail with reference to drawings and embodiments. The embodiments are only used to explain the present invention, but not to limit scope of the present invention.

FIG. 1 shows a structural diagram of a flexible substrate according to an embodiment of the present invention. As shown in FIG. 1, the present embodiment provides a flexible substrate comprising a base 1, wherein a plurality of flexible layers 2 are provided on the base 1, a fiber layer 3 is provided between two adjacent flexible layers 2. The flexible layers 2 are made of resin material.

In the present embodiment, the fiber layer 3 is provided between two flexible layers 2, which can effectively prevent the flexible layers 2 from deformation due to a high temperature, and can reduce stress and increase adhesion of a thin film on the substrate to the greatest extent, and bending and compression strength of the substrate are improved.

Specifically, the resin material preferably is a resin plastic. The resin plastic preferably is made of, for example, polyimide, polyethylene naphthalate or polyethylene terephthalate. Thicknesses of the flexible layers may be of the order of tens of micrometers.

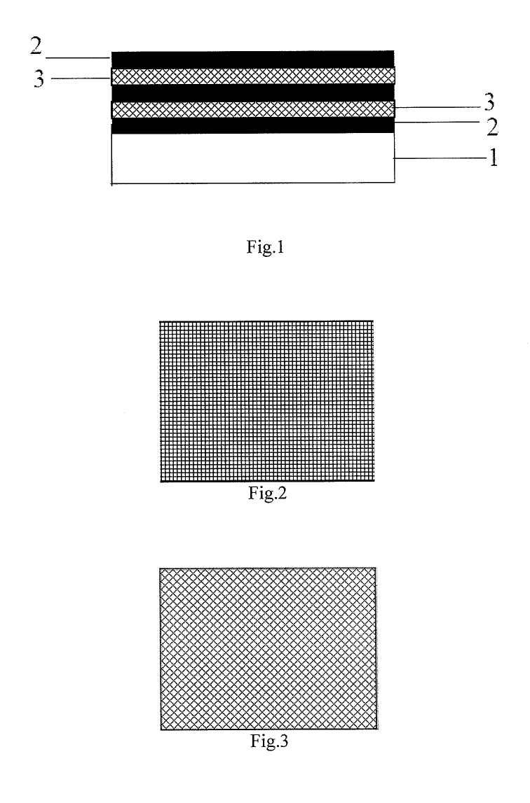

FIG. 2 shows a diagram of fibers in an orthogonal mode in a flexible substrate according to an embodiment of the present invention. FIG. 3 shows a diagram of fibers in another orthogonal mode in a flexible substrate according to an embodiment of the present invention.

Referring to FIGS. 2 and 3, as mechanical forces that a flexible substrate of a flexible display has to bear mainly include bending and compression stress, the fibers are interlaced in (0°, 90°) or (45°, −45°) orthogonal mode, in such mode, compared to other modes, bending and compression properties in different directions can be improved to the greatest extent.

In the present embodiment, the fibers interlacing in (0°, 90°) orthogonal mode specifically refers to that, a portion of the fibers are placed in parallel to X axis and the other portion of the fibers are placed in parallel to Y axis so that the two potions of the fibers are interlaced in 90° orthogonal mode.

It should be noted that, the fibers interlacing in (45°, −45°) orthogonal mode specifically refers to that, a portion of the fibers are placed in a direction at a 45° angle to X axis and the other portion of the fibers are placed in a direction at a 45° angle to Y axis so that the two potions of the fibers are interlaced in 90° orthogonal mode.

Preferably, the fibers may be, for example, glass fibers or carbon fibers.

Preferably, the fibers are in circle bundle shapes. Compared to cases that the fibers are in other shapes, in a case that the fibers are in circle bundle shapes, contact surface area between the fibers and the flexible layers (for example, resin material) is larger, thus bonding strength between the fibers and the flexible layers is larger, and after curing of the flexible layers, the flexible layers are limited to deform in directions of the fibers to some extent, deformation amounts of the flexible layers due to high temperatures are reduced. Therefore, adhesion of a thin film grown on the substrate is increased, and the thin film is prevented from falling off from the substrate.

The flexible substrate of the present invention is formed by flexible layers and fiber layers, which can effectively prevent the flexible layers from deformation due to a high temperature, can reduce stress and increase adhesion of a thin film on the substrate to the greatest extent, and bending and compression strength of the substrate are improved.

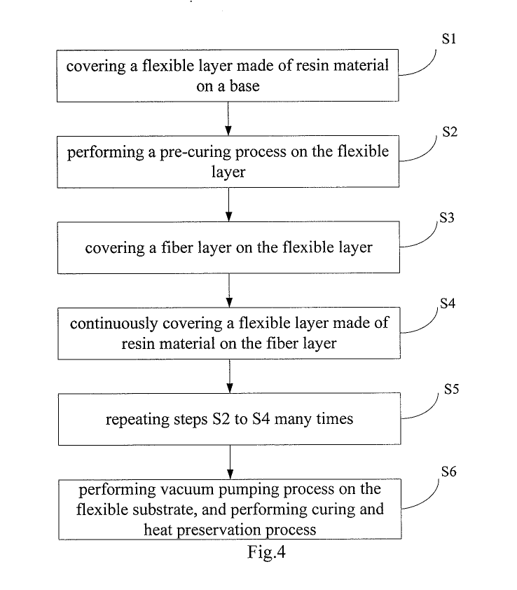

FIG. 4 shows a flowchart of a manufacturing method of a flexible substrate according to an embodiment of the present invention.

As shown in FIG. 4, the present invention also provides a manufacturing method of above flexible substrate. The method comprises following steps of S1 to S6.

Step S1, covering a flexible layer made of resin material on a base.

Preferably, the resin material is resin plastic, and thickness of the resin plastic is of the order of tens of micrometers. The resin plastic preferably is made of polyimide, polyethylene naphthalate or polyethylene terephthalate.

Step S2, performing a pre-curing process on the flexible layer so that the flexible layer has a certain strength and form.

In the present embodiment, curing time of the pre-curing is 80 minutes to 150 minutes, and curing temperature thereof is 80° C. to 200° C.

Step S3, covering a fiber layer on the flexible layer, the fiber layer is formed by interlaced fibers.

Specifically, the fibers are interlaced in (0°, 90°) or (45°, −45°) orthogonal mode, in such mode, compared to other modes, bending and compression properties in different directions can be improved to the greatest extent.

In the present embodiment, the fiber layer is provided between two adjacent flexible layers, which can effectively prevent the flexible layers from deformation due to a high temperature, can reduce stress and increase adhesion of a thin film on the substrate to the greatest extent, and bending and compression strength of the substrate are improved.

Step S4, continuously covering a flexible layer made of resin material on the fiber layer.

Step S5, repeating steps S2 to S4 many times.

Usually, the steps of S2 to S4 are repeated two to four times so that strength of the flexible substrate is increased. Times for repeating the steps of S2 to S4 may be determined in accordance with requirements.

Step S6, after finishing the step S5, performing vacuum pumping process on the flexible substrate, and performing curing and heat preservation process, wherein curing time of the curing is 60 minutes to 120 minutes.

The vacuum pumping process, curing and heat preservation process are performed on the flexible substrate so that volatile components are discharged from the flexible substrate, the layers compounded together are cured and compacted, and holes inside the flexible layers are eliminated, thereby mechanical properties of the flexible substrate are improved.

In the manufacturing method of a flexible substrate of the present invention, the flexible substrate is formed by flexible layers and fiber layers, which can effectively prevent the flexible layers from deformation due to a high temperature, can reduce stress and increase adhesion of a thin film on the substrate to the greatest extent, and bending and compression strength of the substrate are improved.

In addition, the present invention also provides a display apparatus comprising above flexible substrate. The display apparatus may be a liquid crystal panel, an electronic paper, an OLED panel, a mobile phone, a Tablet PC, a television, a display, a notebook PC, a digital photo frame, a navigator, or any of other products or members with a display function.

Above embodiments are only preferable implementations of the present invention. It should be noted that, common persons skilled in the art can make various variations and modifications without departing from the spirit and scope of the present invention, these variations and modifications also should be considered as falling within protection scope of the present invention.

1. A flexible substrate, characterized in that, comprising:
a base, wherein a plurality of flexible layer are provided on the base, and a fiber layer is provided between two adjacent flexible layers.

2. The flexible substrate of claim 1, characterized in that, the flexible layers are made of resin material.

3. The flexible substrate of claim 2, characterized in that, the resin material is resin plastic.

4. The flexible substrate of claim 3, characterized in that, the resin plastic is made of polyimide, polyethylene naphthalate or polyethylene terephthalate.

5. The flexible substrate of claim 1, characterized in that, the fiber layer is formed by interlaced fibers.

6. The flexible substrate of claim 5, characterized in that, the fibers are interlaced in (0°, 90°) or (45°, −45°) orthogonal mode.

7. The flexible substrate of claim 5, characterized in that, the fibers are glass fibers or carbon fibers.

8. The flexible substrate of claim 5, characterized in that, the fibers are in circle bundle shapes.

9. A manufacturing method of a flexible substrate, characterized in that, comprising following steps:
step S1, covering a flexible layer made of resin material on a base;
step S2, performing a pre-curing process on the flexible layer;
step S3, covering a fiber layer on the flexible layer, the fiber layer is formed by interlaced fibers;
step S4, continuously covering a flexible layer made of resin material on the fiber layer;
step S5, repeating steps S2 to S4 many times.

10. The manufacturing method of claim 9, characterized in that, further comprises:
step S6, after finishing the step S5, performing vacuum pumping process on the flexible substrate, and performing curing and heat preservation process.

11. The manufacturing method of claim 9, characterized in that, curing time of the pre-curing in the step S2 is 80 minutes to 150 minutes, and curing temperature thereof is 80° C. to 200° C.

12. The manufacturing method of claim 10, characterized in that, curing time of the curing in the step S6 is 60 minutes to 120 minutes.

13. A display apparatus, characterized in that, comprising the flexible substrate of claim 1.
